(19) United States
(12) Patent Application Publication
(10) Pub. No.: US 2024/0185071 A1
(43) Pub. Date: Jun. 6, 2024

(54) CHANNEL SPECIFIC NEURAL NETWORK PROCESSING

(71) Applicant: Mobileye Vision Technologies Ltd., Jerusalem (IL)

(72) Inventors: Amit WEIZNER, Kiryat Motzkin (IL); Mattan WINAVER, Ramat Ishay (IL)

(21) Appl. No.: 18/529,102

(22) Filed: Dec. 5, 2023

Related U.S. Application Data
(60) Provisional application No. 63/430,209, filed on Dec. 5, 2022.

(51) Int. Cl. G06N 3/08; G06N 3/0495

(52) U.S. Cl. CPC G06N 3/08; G06N 3/0495

(57) ABSTRACT

A method for channel specific neural network processing includes receiving current layer multi-channel output descriptors by next layer neurons. The current layer multi-channel output descriptors are provided by neurons of the current layer. The current layer and the next layer belong to a neural network. The next layer neurons process the current layer multi-channel output descriptors to provide next layer multi-channel output descriptors. The processing includes multiplying the current layer multi-channel output descriptors by channel compensated weights of the next layer neurons to provide next layer products that compensate for estimated differences between scale factors associated with different channels of the current layer multi-channel output descriptors. The next layer products are quantized by applying next layer output channel specific quantization.

### CROSS-REFERENCE TO RELATED APPLICATIONS

This application claims the benefit of priority of U.S. Provisional Patent Application No. 63/430,209, filed on Dec. 5, 2022, the contents of which are incorporated herein in their entirety.

### BACKGROUND

The popularity of neural networks has dramatically increased during the last decade. A typical neural network includes multiple layers such as an input layer, one or more hidden layers, and an output layer. Each layer of the multiple layers includes multiple neurons.

Each layer may receive multiple layer input descriptors, and each layer input descriptor may include content from one or more layer input channels that may be arranged in one or more layer input descriptor segments, with one layer input descriptor segment per channel.

Each layer may process the multiple layer input descriptors to provide multiple layer output descriptors, and each layer output descriptor may include content from one or more layer output channels that may be arranged in one or more layer output descriptor segments, with one layer output descriptor segment per channel.

A neuron of the neural network includes multiple input multipliers that are configured to receive multiple input values and multiply them by corresponding neuron weights to provide multiple products. The multiple products are added, by an accumulator, to provide a sum. The sum may be quantized to provide a quantized sum. A neural activation function is applied on the quantized sum to provide a neuron output.

A distribution of values of content from different channels of the multiple layer input channels may vary from one channel and the other. Distributions of values of different channels may significantly vary from one channel to another.

There is a growing need to provide channel specific neural network processing.

### SUMMARY

There may be provided a system, a method, and a computer readable medium for neural network processing with quantization.

### BRIEF DESCRIPTION OF THE DRAWINGS

FIG. 1 illustrates an example of a multiply and accumulate unit;

FIG. 2 illustrates an example of a method;

FIG. 3 illustrates an example of a method;

FIG. 4 illustrates an example of a method;

FIG. 5 illustrates an example of neural networks;

FIG. 6 illustrates an example of a system and a reference neural network system; and

FIG. 7 illustrates an example of a method.

### DETAILED DESCRIPTION

In the following detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer readable medium that is non-transitory and stores instructions for executing the method.

Any reference in the specification to a system should be applied mutatis mutandis to a method that may be executed by the system and should be applied mutatis mutandis to a computer readable medium that is non-transitory and stores instructions executable by the system.

Any reference in the specification to a computer readable medium that is non-transitory should be applied mutatis mutandis to a method that may be applied when executing instructions stored in the computer readable medium and should be applied mutatis mutandis to a system configured to execute the instructions stored in the computer readable medium.

The term “and/or” means additionally or alternatively.

Any reference to the term “mimic” should be applied mutatis mutandis to the term “approximate.” Both terms may mean that a neural network that approximates a reference neural network is expected to perform substantially the same neural network processing.

The phrase “substantially equal” may mean equal to or differ up to an allowable deviation. The allowable deviation may be set to be a certain percentage of a value, for example, 1, 2, 3, 4, 5, 6, 7, 8, 9, 10, 15, 20, 25, 30 percent, and the like. Alternatively, the allowable deviation from the exact value may be determined based on a desired accuracy of a process (for example, neural network processing) applied by a neural network or a layer of the neural network when applying values that are substantially equal to a desired value. The desired accuracy may be defined in any manner, for example, in advance, by a user of the neural network processing, by a neural network architect or programmer, and the like. The desired accuracy may be, for example, accuracy of 85, 90, 95, 98, or 99 percent. There may be an allowable tradeoff between computation resources required to execute the neural network processing and the accuracy of the neural network processing. The tradeoff may be defined in any manner, for example, in advance, by a user of the neural network processing, by a neural network architect or programmer, and the like.

The following text may refer to different examples of number formats such as floating point and fixed point and to different examples of number lengths, for example, 32 bit, 16 bit, and 8 bit. These are merely non-limiting example of lengths and/or formats.

A quantization factor (or a compression factor) is a relationship of a size (a number of bits) of a value before the quantization and the size of the value after the quantization.

The following text may also refer to different examples of quantization factors, for example, from 32 bit to 8 bit. These are merely non-limiting example of quantization factors.

There is provided a method, a system, and a non-transitory computer readable medium for channel specific neural network processing. The channel specific neural network processing may include or may facilitate performing channel specific quantization of outputs of neurons.

The channel specific neural network processing allows application of different quantization scales per each output channel without using dedicated hardware multipliers for compensating for the different quantization scales. The weights of neurons of a next layer (NL) of neurons may be set to compensate for differences between scale factors of different channels of a current layer (CL) that preceded the NL.

This enables neurons that received content from different channels to perform multiplication operations on the content from the different channels to provide neuron products and then add the neuron products while applying channel compensation weights without allocating dedicated multipliers to align the content from the different channels before the multiplications.

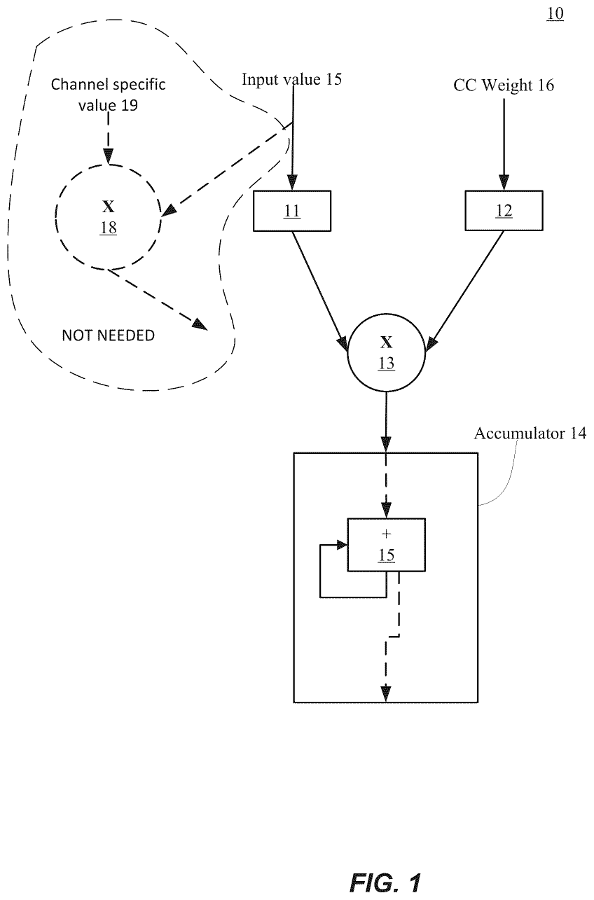

FIG. 1 illustrates an example of a multiply accumulate unit (MAC) 10.

MAC 10 may perform some or all operations of one or more neurons of a neural network.

MAC 10 is configured to perform a sequence of multiplication and accumulation operations, one after the other. Two or more multiplication and accumulation operations are applied on input values from different input channels.

MAC 10 includes a first input 11, a second input 12, a multiplier 13, and an accumulator 14.

During each multiplication and accumulation operation, (i) the first input 11 is configured to receive an input value 15 of a certain input channel, (ii) the second input 12 is configured to receive a channel compensated (CC) weight 16, (iii) the multiplier 13 is configured to multiply the input value 15 by the CC weight 16 to provide a product, and (iv) the accumulator 14 is configured to add a current value of the accumulator to the product to provide an accumulated value.

The provision of the CC weight 16 saves using a dedicated multiplier 18 for multiplying the input value 15 by a channel specific value 19.

The accumulator 14 is followed by a quantization unit (not shown in FIG. 1) that is activated once the sequence of multiplication and accumulation operations ends, for example, after processing content from different input channels.

For example, MAC 10 may perform some of the operations of one or more neurons that are configured to process segments of a multiple-channel input descriptor. Different segments of the multiple-channel input descriptor are associated with different input channels.

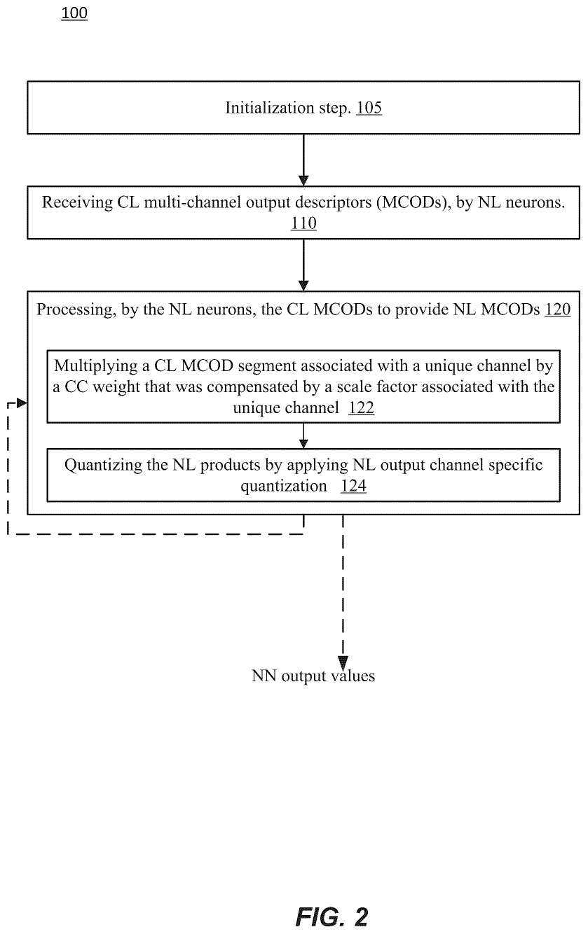

FIG. 2 illustrates an example of a method 100 for channel specific neural network processing. Method 100 begins with initialization step 105 and includes obtaining information required for executing other steps of method 100.

Step 105 may include obtaining the CC weights, wherein the CC weights are determined by training the NN to provide trained weights and modifying the trained weights by correction factors that represent the estimated differences.

Steps 110 and 120 are executed by next layer (NL) neurons that receive values from current layer (CL) neurons. The NN may include multiple pairs of NL and CL neurons, whereas each hidden layer of the NN may be a NL for a previous layer of the NN and a CL for a following layer. The input layer of the NN may be a CL but not a NL, and the output layer of the NN may be a NL but not a CL.

Step 110 of method 100 includes receiving CL multi-channel output descriptors (MCODs), by NL neurons. A descriptor is a way of representing data in a machine learning model. A multi-channel output descriptor is a way of representing data from multiple output channels. For example, a color image may include three channels, i.e., red, green, and blue. The CL MCODs are provided by neurons of the CL.

Step 120 of method 100 includes processing, by the NL neurons, the CL MCODs to provide NL MCODs.

Step 120 may include step 122 of multiplying the CL MCODs by channel compensated (CC) weights of the NL neurons to provide NL products. The CC weights compensate for estimated differences between scale factors associated with different channels of the CL MCODs.

The CC weights virtually align the scale factors associated with the different channels of the CL MCODs. The alignment allows the NL neurons to add (without using dedicated hardware multipliers) products of multiplications of CL MCOD segments of different input channels.

The NL output channel specific quantization allows channel specific quantization factors to be applied, as the layer that follows the NL will compensate for the different channel specific quantization factors.

Each CL MCOD may include multiple CL MCOD segments. Each CL MCOD segment is associated with a unique channel out of multiple CL MCOD channels.

Step 122 may include multiplying a CL MCOD segment associated with a unique channel by a CC weight that was compensated by a scale factor associated with the unique channel. This multiplication may be executed by a single multiplication element and is executed for each unique channel of the multiple channels of the CL MCOD.

Step 120 may also include step 124 of quantizing the NL products by applying NL output channel specific quantization.

Neurons of the input layer of the NN may receive multi-channel inputs and not CL MCODs, but may provide CL MCODs to be sent to the first hidden layer.

Repetitions of steps 110 and 120 may continue for each pair of adjacent layers of the NN until reaching the output layer of the NN. The output layer of the NN may be regarded as the last NL of the NN.

Method 100 may be executed during the training of the NN and/or during inference.

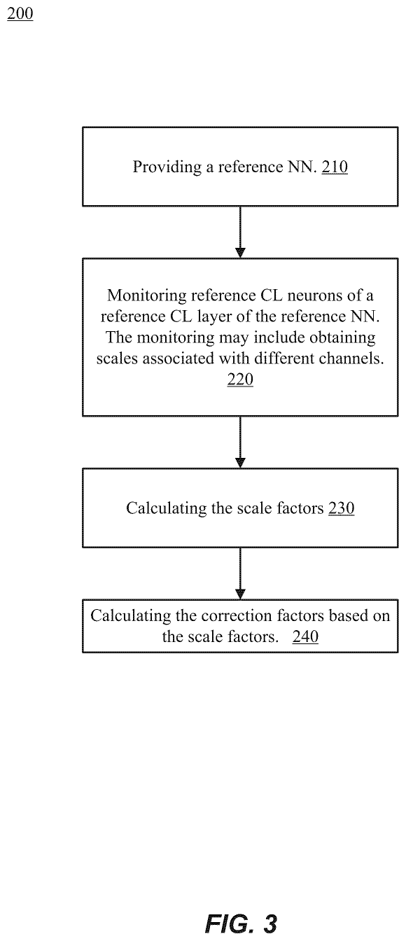

FIG. 3 illustrates a method 200 for obtaining correction factors. The correction factors are calculated based on an estimation of differences between scale factors associated with different channels.

Method 200 begins with step 210 of providing a reference NN. The reference NN may be approximated by the NN. The reference NN may be generated during a compilation process.

Step 220 of method 200 includes monitoring reference CL neurons of a reference CL layer of the reference NN. The monitoring may include obtaining scales associated with different channels. In order to determine the correction factors related to a NL of a NN, the scales associated with a reference CL of a reference NN should be learned.

Step 230 of method 200 includes calculating the scale factors based on the scales.

Step 240 of method 200 includes calculating the correction factors based on the scale factors. For example, the correction factors may equal the scale factors, may be a reciprocal of the value, or any other function.

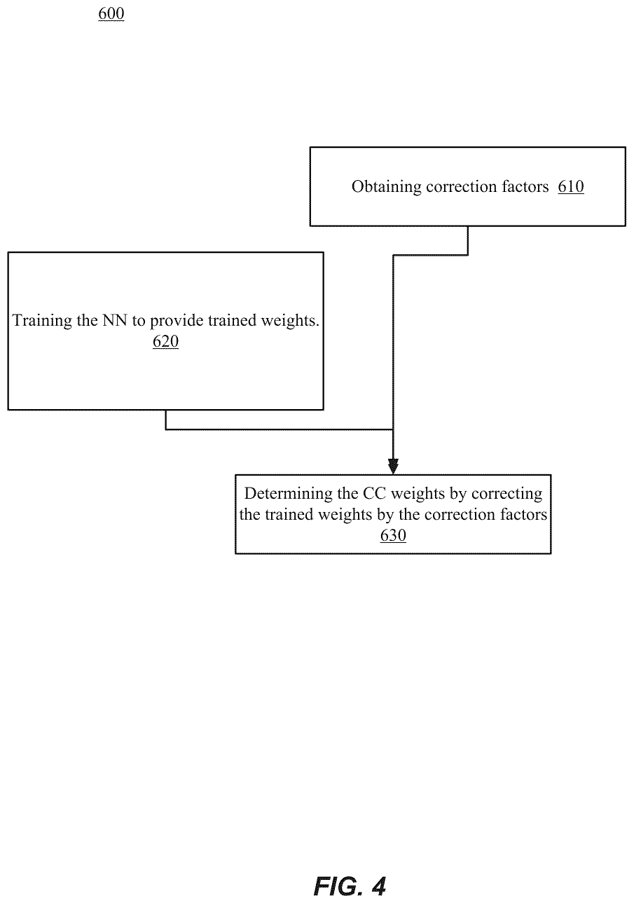

FIG. 4 illustrates an example of a method 600 for determining CC weights of a NN. Method 600 may start by steps 610 and 620. Step 610 may include obtaining correction factors. Step 620 may include training the NN to provide trained weights.

Step 630 of method 600 includes determining the CC weights by correcting the trained weights by the correction factors. The correcting may include multiplying or applying any other operation.

Method 600 may be included in step 105 of method 100.

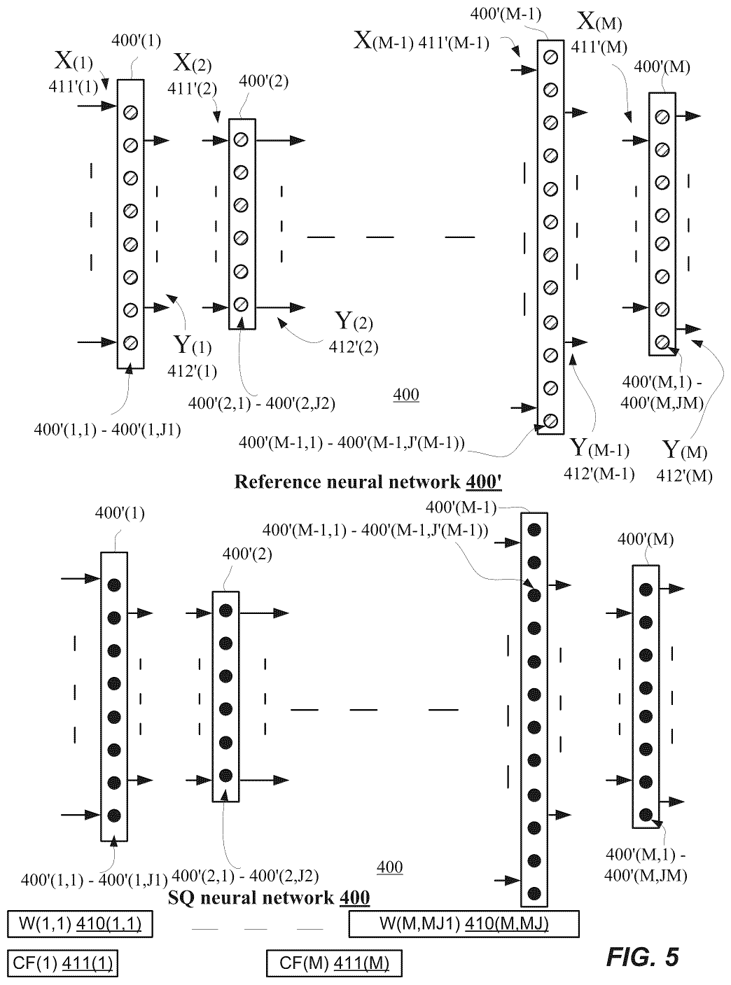

FIG. 5 illustrates examples of a neural network 400, reference neural network 400′, and various values.

Reference neural network 400′ includes M (positive integer) reference layers 400′(1)-400′(M−1). For simplicity of explanation, FIG. 5 explicitly illustrates the first reference layer 400′(1), the second reference layer 400′(2), the penultimate reference layer 400′(M−1), and the last reference layer 400′(M).

The first reference layer includes J1 neurons 400′(1,1)-400(1,J1). The second reference layer includes J1 neurons 400′(2,1)-400(2,J2). The penultimate reference layer includes J(M−1) neurons 400′(M−1,1)-400(M−1,J(M−1)). The last reference layer includes JM neurons 400′(M,1)-400(M,JM). JM is the number of neurons of the J′th layer. J(M−1) is the number of neurons of the (M−1)′th layer.

The first reference layer 400′(1) is fed by first reference layer input values X(1) and outputs first reference layer output values Y(1). The second reference layer 400′(2) is fed by second reference layer input values X(2) and outputs second reference layer output values Y(2). The penultimate reference layer 400′(1) is fed by penultimate reference layer input values X(M−1) and outputs penultimate reference layer output values Y(M−1). The last reference layer 400′(M) is fed by last reference layer input values X(M) and outputs last reference layer output values Y(M).

These values are used to determine the one or more scale factors that may be used for amending the weight of the neural network 400. Other values may be used.

Neural network 400 includes M (positive integer) layers 400(1)-400(M−1). For simplicity of explanation, FIG. 5 explicitly illustrates the first layer 400(1), the second layer 400(2), the penultimate layer 400(M−1), and the last layer 400(M).

The first layer includes J1 neurons 400(1,1)-400(1,J1). The second layer includes J1 neurons 400(2,1)-400(2,J2). The penultimate layer includes J(M−1) neurons 400(M−1,1)-400(M−1, J(M−1)). The last layer includes JM neurons 400(M,1)-400(M, JM).

FIG. 5 also shows the channel compensated (CC) weights of the neural network, from the CC weight of the first neuron of the first layer W(1,1) 410(1,1) to the last CC weight of the last neuron of the last layer W(M,MJ) 410(M,MJ).

FIG. 5 also shows the one or more correction factors obtained during initialization step 105. From the first one or more correction factors CF(1) 411(1) related to weights of the neurons of the first layer to the last one or more correction factors CF(M) 411(M) related to weights of the neurons of the last layer.

The number of layer input descriptors of a layer may differ from a number of layer output descriptors of the layer. The number of layer input channels of a layer input descriptor may differ from the number of layer output channels of a layer output descriptor. The number of layer input descriptors of one layer may differ from the number of layer input descriptors of another layer. The number of layer output descriptors of one layer may differ from the number of layer output descriptors of another layer.

The neural network may be implemented by one or more processing circuits. A processing circuit may be implemented as a central processing unit (CPU) and/or one or more other integrated circuits such as application-specific integrated circuits (ASICs), field programmable gate arrays (FPGAs), full-custom integrated circuits, etc., or a combination of such integrated circuits. The reference neural network may be implemented by much more processing circuits, for example, may be implemented by a group of servers.

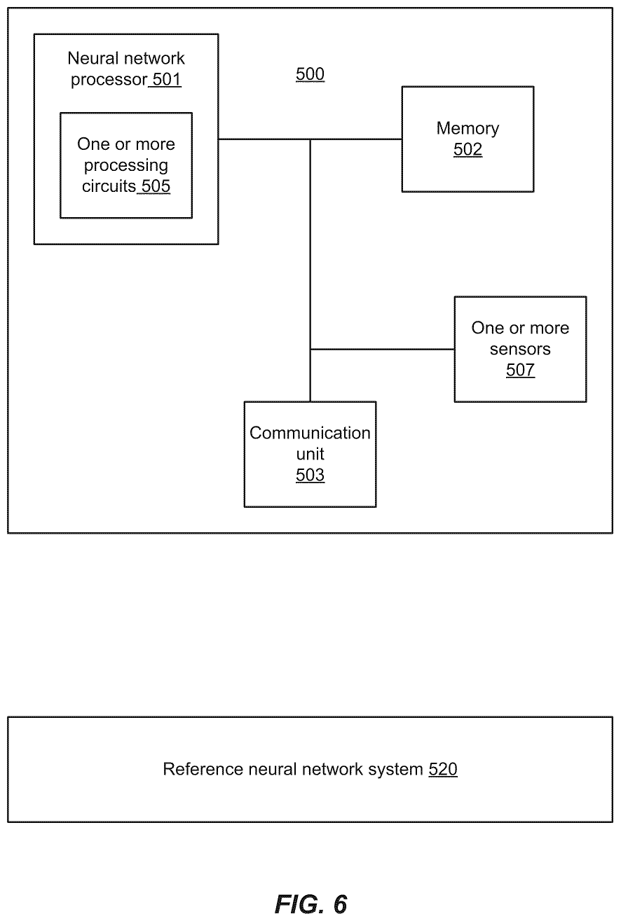

FIG. 6 is an example of a system 500 and of a reference neural network system 520. System 500 includes a memory 502, a communication unit 503, and a neural network processor 501 that includes one or more processing circuits 505. The neural network processor 501 may include its own memory unit (in addition to or instead of memory 502) and/or may have its own communication unit (in addition to or instead of communication unit 503).

System 500 may include one or more sensors 507 or may be fed by information from one or more sensors, e.g. cameras, Lidars, Radars. The information (for example, input images or other input sensed information) may be processed by the one or more processing circuits. The reference neural network system 520 is configured to perform reference neural network processing operations. The reference neural network system 520 may execute the monitoring process and/or a training of the reference neural network. The reference neural network system 520 includes more computation resources than system 500.

The neural network processor 501 may include one or more processing circuits that are configured to receive current layer (CL) multi-channel output descriptors (MCODs). Next layer (NL) neurons may receive the CL MCODs from neurons of the CL. The CL and the NL belong to a neural network (NN) that processes the CL MCODs to provide NL MCODs. The processing may include multiplying the CL MCODs by channel compensated (CC) weights of the NL neurons to provide NL products that compensate for estimated differences between scale factors associated with different channels of the CL MCODs; and quantize the NL products by applying NL output channel specific quantization.

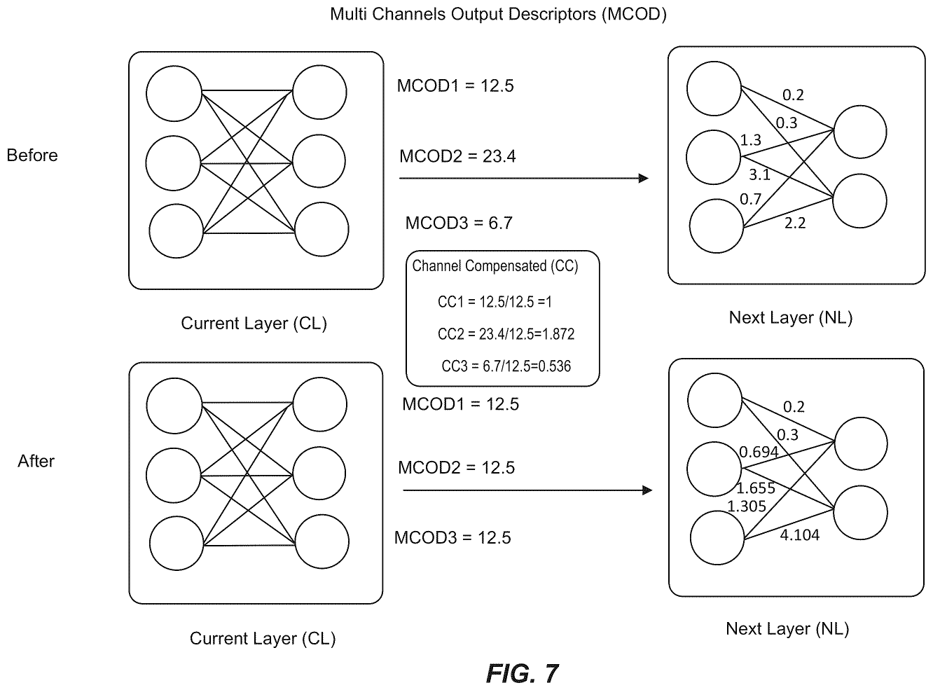

FIG. 7 illustrates an example of a method performed in accordance with some embodiments of the disclosure. The neural network used in this example includes two layers: a current layer (CL) and a next layer (NL). The “before” figures represent an example method before the present disclosure is applied and the “after” figures represent an example method with the present disclosure applied.

As shown in the “before” portion FIG. 7, the MCODs of the current layer are provided to the next layer. For example, MCOD1=12.5, MCOD2=23.4, and MCOD3=6.7. Based on the weights associated with each neuron, the outputs are calculated by multiplying the MCOD by the neuron weights, with the resulting weights as shown in the right-side figure.

As shown in the middle box of FIG. 7, the channel compensated (CC) weights are calculated. For example, the CC weights may be calculated by taking a median value of the MCODs. In the example, the median value is 12.5. The other MCODs are then scaled by the median value (i.e., divided by the median value) to obtain the CC weights which are then used to scale and rectify the next layer weights. For example, the NL weights (shown in the top right portion of FIG. 7) are divided by the corresponding CC weights to obtain the scaled NL weights (shown in the bottom right portion of FIG. 7). It is noted that while the median value is selected as a way to scale the MCODs, other scaling methods for the MCODs may be used.

It is noted that the above example process may be performed iteratively during training or may be performed as a one-time modification during network deployment.

System 500 or neural network processor 501 may be configured to execute method 100.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

The connections as discussed herein may be any type of connection suitable to transfer signals from or to the respective nodes, units, or devices, for example, via intermediate devices. Accordingly, unless implied or stated otherwise, the connections may, for example, be direct connections or indirect connections. The connections may be illustrated or described in reference to a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations, and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations, and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments of the disclosure containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments of the disclosure have been illustrated and described herein, many modifications, substitutions, changes, and equivalents will now occur to those of ordinary skill in the art. It is, therefore, to be understood that the appended claims are intended to cover all such modifications and changes as fall within the scope of the embodiments of the disclosure.

What is claimed is:

1. A method for channel specific neural network processing, comprising:
(a) receiving current layer multi-channel output descriptors by next layer neurons, wherein the current layer multi-channel output descriptors are provided by neurons of the current layer and the current layer and the next layer belong to a neural network; and
(b) processing, by the next layer neurons, the current layer multi-channel output descriptors to provide next layer multi-channel output descriptors, wherein the processing comprises:
multiplying the current layer multi-channel output descriptors by channel compensated weights of the next layer neurons to provide next layer products that compensate for estimated differences between scale factors associated with different channels of the current layer multi-channel output descriptors; and
quantizing the next layer products by applying next layer output channel specific quantization.

2. The method according to claim 1, wherein the channel compensated weights virtually align the scale factors associated with the different channels of the current layer multi-channel output descriptors.

3. The method according to claim 1, wherein each current layer multi-channel output descriptor of the current layer multi-channel output descriptors comprises multiple current layer multi-channel output descriptor segments, each current layer multi-channel output descriptor segment is associated with a unique channel out of multiple current layer multi-channel output descriptor channels.

4. The method according to claim 3, wherein the multiplying of the current layer multi-channel output descriptors comprises multiplying a current layer multi-channel output descriptor segment associated with a unique channel by a channel compensated weight that was compensated by a scale factor associated with the unique channel.

5. The method according to claim 4, wherein the multiplying of the current layer multi-channel output descriptor segment associated with the unique channel by the channel compensated weight is executed by a single multiplication element.

6. The method according to claim 1, wherein the estimated differences are learned by monitoring reference current layer neurons of a reference current layer of a reference neural network that is approximated by the neural network.

7. The method according to claim 6, further comprising:
determining the channel compensated weights by:
training the neural network to provide trained weights; and
modifying the trained weights by correction factors that represent the estimated differences.

8. The method according to claim 1, wherein the neural network comprises multiple layers and the method comprises performing step (a) and step (b) for at least two pairs of consecutive layers of the multiple layers.

9. A non-transitory computer readable medium for channel specific neural network processing, the non-transitory computer readable medium storing instructions that, once executed by one or more processing circuits, causes the one or more processing circuits to:
receive current layer multi-channel output descriptors by next layer neurons, wherein the current layer multi-channel output descriptors are provided by neurons of the current layer and the current layer and the next layer belong to a neural network; and
process, by the next layer neurons, the current layer multi-channel output descriptors to provide next layer multi-channel output descriptors, wherein processing of the current layer multi-channel output descriptors comprises:
multiplying the current layer multi-channel output descriptors by channel compensated weights of the next layer neurons to provide next layer products that compensate for estimated differences between scale factors associated with different channels of the current layer multi-channel output descriptors; and
quantizing the next layer products by applying next layer output channel specific quantization.

10. The non-transitory computer readable medium according to claim 9, wherein the channel compensated weights virtually align the scale factors associated with the different channels of the current layer multi-channel output descriptors.

11. A neural network processor, comprising:
one or more processing circuits that are configured to:
receive current layer multi-channel output descriptors by next layer neurons, wherein the current layer multi-channel output descriptors are provided by neurons of the current layer and the current layer and the next layer belong to a neural network; and
process the current layer multi-channel output descriptors to provide next layer multi-channel output descriptors, wherein the processing comprises:
multiplying the current layer multi-channel output descriptors by channel compensated weights of the next layer neurons to provide next layer products that compensate for estimated differences between scale factors associated with different channels of the current layer multi-channel output descriptors; and
quantizing the next layer products by applying next layer output channel specific quantization.

12. The neural network processor according to claim 11, wherein the channel compensated weights virtually align the scale factors associated with the different channels of the current layer multi-channel output descriptors.

13. The neural network processor according to claim 11, wherein each current layer multi-channel output descriptor of the current layer multi-channel output descriptors comprises multiple current layer multi-channel output descriptor segments, each current layer multi-channel output descriptor segment is associated with a unique channel out of multiple current layer multi-channel output descriptor channels.

14. The neural network processor according to claim 13, wherein the multiplying of the current layer multi-channel output descriptors comprises multiplying a current layer multi-channel output descriptor segment associated with a unique channel by a channel compensated weight that was compensated by a scale factor associated with the unique channel.

15. The neural network processor according to claim 14, wherein the multiplying of the current layer multi-channel output descriptor segment associated with the unique channel by the channel compensated weight is executed by a single multiplication element.

16. The neural network processor according to claim 11, wherein the estimated differences are learned by monitoring reference current layer neurons of a reference current layer of a reference neural network that is approximated by the neural network.

17. The neural network processor according to claim 16, wherein the neural network processor is further configured to:
determine the channel compensated weights by:
training the neural network to provide trained weights; and
modifying the trained weights by correction factors that represent the estimated differences.

18. The neural network processor according to claim 11, wherein the neural network comprises multiple layers and the neural network processor is further configured to:
receive the current layer multi-channel output descriptors and process the current layer multi-channel output descriptors for at least two pairs of consecutive layers of the multiple layers.

19. A method for channel specific neural network processing in a neural network including current layer neurons and next layer neurons, the method comprising:
multiplying current layer multi-channel output descriptors by channel compensated weights of the next layer neurons to provide next layer products, wherein the next layer products compensate for estimated differences between scale factors associated with different channels of the current layer multi-channel output descriptors; and
quantizing the next layer products by applying next layer output channel specific quantization to provide next layer multi-channel output descriptors.

20. The method according to claim 19, wherein the channel compensated weights virtually align the scale factors associated with the different channels of the current layer multi-channel output descriptors.

21. The method according to claim 19, wherein each current layer multi-channel output descriptor of the current layer multi-channel output descriptors comprises multiple current layer multi-channel output descriptor segments, each current layer multi-channel output descriptor segment is associated with a unique channel out of multiple current layer multi-channel output descriptor channels.

22. The method according to claim 21, wherein the multiplying of the current layer multi-channel output descriptors comprises multiplying a current layer multi-channel output descriptor segment associated with a unique channel by a channel compensated weight that was compensated by a scale factor associated with the unique channel.

23. The method according to claim 22, wherein the multiplying of the current layer multi-channel output descriptor segment associated with the unique channel by the channel compensated weight is executed by a single multiplication element.

24. The method according to claim 19, wherein the estimated differences are learned by monitoring reference current layer neurons of a reference current layer of a reference neural network that is approximated by the neural network.

25. The method according to claim 24, further comprising:
determining the channel compensated weights by:
training the neural network to provide trained weights; and
modifying the trained weights by correction factors that represent the estimated differences.

26. The method according to claim 19, wherein the neural network comprises multiple layers and the method comprises performing the multiplying and the quantizing for at least two pairs of consecutive layers of the multiple layers.

27. A neural network processor for channel specific neural network processing in a neural network including current layer neurons and next layer neurons, the neural network processor comprising:
one or more processing circuits configured to:
multiply current layer multi-channel output descriptors by channel compensated weights of the next layer neurons to provide next layer products, wherein the next layer products compensate for estimated differences between scale factors associated with different channels of the current layer multi-channel output descriptors; and
quantize the next layer products by applying next layer output channel specific quantization to provide next layer multi-channel output descriptors.

28. The neural network processor according to claim 27, wherein the channel compensated weights virtually align the scale factors associated with the different channels of the current layer multi-channel output descriptors.

29. The neural network processor according to claim 27, wherein each current layer multi-channel output descriptor of the current layer multi-channel output descriptors comprises multiple current layer multi-channel output descriptor segments, each current layer multi-channel output descriptor segment is associated with a unique channel out of multiple current layer multi-channel output descriptor channels.

30. The neural network processor according to claim 29, wherein the multiplying of the current layer multi-channel output descriptors comprises multiplying a current layer multi-channel output descriptor segment associated with a unique channel by a channel compensated weight that was compensated by a scale factor associated with the unique channel.

31. The neural network processor according to claim 30, wherein the multiplying of the current layer multi-channel output descriptor segment associated with the unique channel by the channel compensated weight is executed by a single multiplication element.

32. The neural network processor according to claim 27, wherein the estimated differences are learned by monitoring reference current layer neurons of a reference current layer of a reference neural network that is approximated by the neural network.

33. The neural network processor according to claim 32, wherein the neural network processor is further configured to:
determine the channel compensated weights by:
training the neural network to provide trained weights; and
modifying the trained weights by correction factors that represent the estimated differences.

34. The neural network processor according to claim 27, wherein the neural network comprises multiple layers and the neural network processor is further configured to:
receive the current layer multi-channel output descriptors; and
process the current layer multi-channel output descriptors for at least two pairs of consecutive layers of the multiple layers.
